(19) United States
(12) Patent Application Publication
(10) Pub. No.: US 2005/0088590 A1
(43) Pub. Date: Apr. 28, 2005

(54) Method and apparatus for enhancing a contrast ratio of a liquid crystal display

(75) Inventors: Tung-Lung Li, Ping Chen City (TW); Wei-Duz Hong, Ping Chen City (TW); Long-Hai Wu, Ping Chen City (TW); Ta-Wang Lai, Ping Chen City (TW)

Correspondence Address: SUGHRUE MION, PLLC, 2100 PENNSYLVANIA AVENUE, N.W., SUITE 800, WASHINGTON, DC, 20037, US

(73) Assignee: OPTIMAX TECHNOLOGY CORPORATION

(21) Appl. No.: 10/919,374

(22) Filed: Aug. 17, 2004

(30) Foreign Application Priority Data
Oct. 22, 2003 (TW) 92129350

(51) Int. Cl. G02F 1/1333

(52) U.S. Cl. 349/110

(57) ABSTRACT

A liquid crystal display has a liquid crystal display panel, a backlight and a dark layer. The liquid crystal display panel has an upper polarizer, a liquid crystal cell, and a lower polarizer, and the two polarizers both have wide view optical compensation films. The light emitted from the backlight is transmitted to a viewer through the lower polarizer, the liquid crystal cell, and the upper polarizer, sequentially. The dark layer of the invention is placed between the backlight and the viewer, and it lowers the dark-state brightness of the liquid crystal display to improve the downward angle view contrast ratio thereof to be greater than 10.

### BACKGROUND

1. Field of Invention

The present invention relates to a liquid crystal display. More particularly, the present invention relates to a method and apparatus for enhancing the contrast ratio of the liquid crystal display.

2. Description of Related Art

Liquid crystal display (LCD) has many advantages over other conventional types of displays including high display quality, small volume, light weight, low driving voltage and low power consumption. Hence, LCDs are widely used in small portable televisions, mobile telephones, video recording units, notebook computers, desktop monitors, projector televisions and so on, and have gradually replaced the conventional cathode ray tube (CRT) as a mainstream display unit. Therefore, the market is mainly occupied by LCDs due to the high display quality and the low power consumption of the LCDs. Large size, high resolution, wide view and rapid response time are the main demands on the LCDs.

Some popular wide view techniques are developed, such as In-Plane Switching (IPS), Optical Compensated Birefringence (OCB), Multi-Domain Vertical Alignment (MVA), wide view optical compensation films and any combination thereof. The simplest one of these wide view techniques is to insert the wide view optical compensation films into a liquid crystal display panel, which increases the view-angle of the LCD to between about 140 and 160 degrees. This kind of wide view technique is available to liquid crystal displays in different sizes, and only inserts the wide view optical compensation films into the LCD without changing the manufacturing processes thereof.

FIG. 1 illustrates a schematic view of a conventional liquid crystal display having wide view optical compensation films. As illustrated in FIG. 1, a wide view optical compensation film 102 comprises uniaxial material, the optical characteristics of which are complementary to those of the liquid crystal molecules in a liquid crystal cell 104. The uniaxial material has a negative optical anisotropy, and a polarizing axial thereof is changed dependent on the thickness of the wide view optical compensation film 102, thus increasing the view-angle of the LCD.

The wide view optical compensation film 102 is formed by coating or solvent casting a material with a negative optical anisotropy, such as a discotic liquid crystal material, an inorganic material, or a cholesterin liquid crystal material, on a transparent supporting substrate. The largest vendor of the wide view optical compensation film at present is Fuji Photo Film Corp. Generally, in the whole manufacturing process of the liquid crystal display panel, the polarizer manufacturer adheres the wide view optical compensation film to the polarizer, and then sells it to the panel manufacturer for subsequent manufacturing.

However, in the conventional method, which uses the wide view optical compensation films to increase the view-angel of the LCD, a light leak usually occurs when the LCD is viewed at a downward angle. Moreover, a contrast ratio of the LCD is defined as a ratio of a light-state brightness to a dark-state brightness thereof, and usually must be greater than 10 to qualify. Because of the aforementioned light leak, the contrast ratio of the downward angle view of the LCD, which uses the wide view optical compensation films to increase the view-angle thereof, is decreased and thus causing a bad contrast ratio of the LCD.

### SUMMARY

It is therefore an objective of the present invention to provide a method for enhancing the contrast ratio of a liquid crystal display having wide view optical compensation films.

It is another an objective of the present invention to provide a liquid crystal display in which a dark layer therein lowers the brightness to improve a downward angle view contrast ratio thereof.

It is still another an objective of the present invention to provide a shading apparatus, placed between a liquid crystal display and a viewer to satisfy the both requirements of wide view-angle and high contrast ratio of the liquid crystal display.

It is still another an objective of the present invention to provide a polarizer in which a dark layer therein lowers the brightness to improve a downward angle view contrast ratio of a liquid crystal display having the polarizer.

In accordance with the foregoing and other objectives of the present invention, a method and apparatus for enhancing a contrast ratio of a liquid crystal display are provided. A liquid crystal display has a liquid crystal display panel, a backlight and a dark layer. The liquid crystal display panel has an upper polarizer, a liquid crystal cell, and a lower polarizer, and the two polarizers both have wide view optical compensation films. The light emitted from the backlight is transmitted to a viewer through the lower polarizer, the liquid crystal cell, and the upper polarizer, sequentially. The dark layer of the invention is placed between the backlight and the viewer, and it lowers the dark-state brightness of the liquid crystal display to improve the downward angle view contrast ratio thereof to be greater than 10.

According to one preferred embodiment of the invention, the dark layer is a black dye coating layer or an adhesive layer with a black dye. A material of the black dye is AAA. The position of the dark layer is on an outside of the upper polarizer, between the upper polarizer and the liquid crystal cell, between the lower polarizer and the liquid crystal cell, or between the lower polarizer and the backlight.

According to another preferred embodiment of the invention, the invention provides a shading apparatus. The shading apparatus comprises a dark layer and a fixing apparatus, and the dark layer is fixed on a liquid crystal display with the fixing apparatus. The dark layer includes a transparent substrate and a black dye. A material of the black dye is a AAA, and a material of the transparent substrate is polycarbonate, acrylic or plastic.

According to another preferred embodiment of the invention, the invention provides a polarizer used in a liquid crystal display. The polarizer comprises a supporting film, a polarizing film on the supporting film, a wide view optical compensation film on the polarizing film and a dark layer in the polarizer. The dark layer also lowers a dark-state brightness of the liquid crystal display to improve a downward angle view contrast ratio of the liquid crystal display to be greater than 10. In this embodiment, the dark layer is an adhesive layer with a black dye, and a material of the dark layer is AAA.

The invention uses a simple way to solve the light leak of the conventional wide view optical compensation films and improve the contrast ratio of the liquid crystal display, and can be widely used in the liquid crystal displays of desktop computers or notebooks.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims and accompanying drawings, where:

FIG. 1 illustrates a schematic view of a conventional liquid crystal display having wide view optical compensation films;

FIG. 2A illustrates a schematic views of one preferred embodiment of a liquid crystal display of the invention;

FIG. 2B illustrates a schematic views of another preferred embodiment of a liquid crystal display of the invention;

FIG. 2C illustrates a schematic views of another preferred embodiment of a liquid crystal display of the invention;

FIG. 2D illustrates a schematic views of another preferred embodiment of a liquid crystal display of the invention;

FIG. 3 illustrates a schematic view of one preferred embodiment of the polarizer of the invention; and

FIG. 4 illustrates a schematic view of another preferred embodiment of the shading apparatus of the invention.

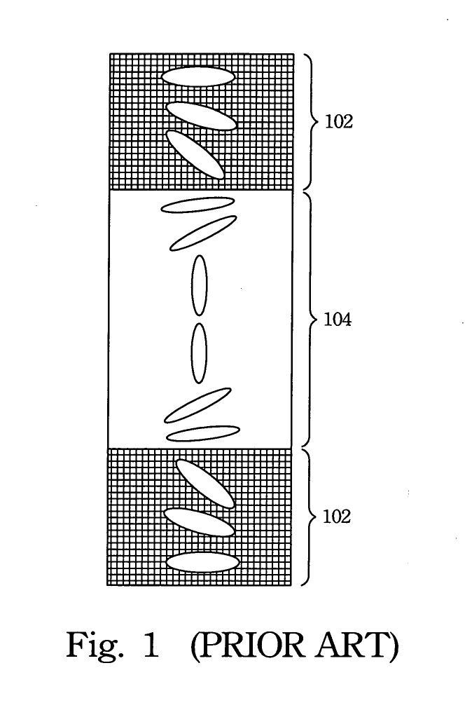

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

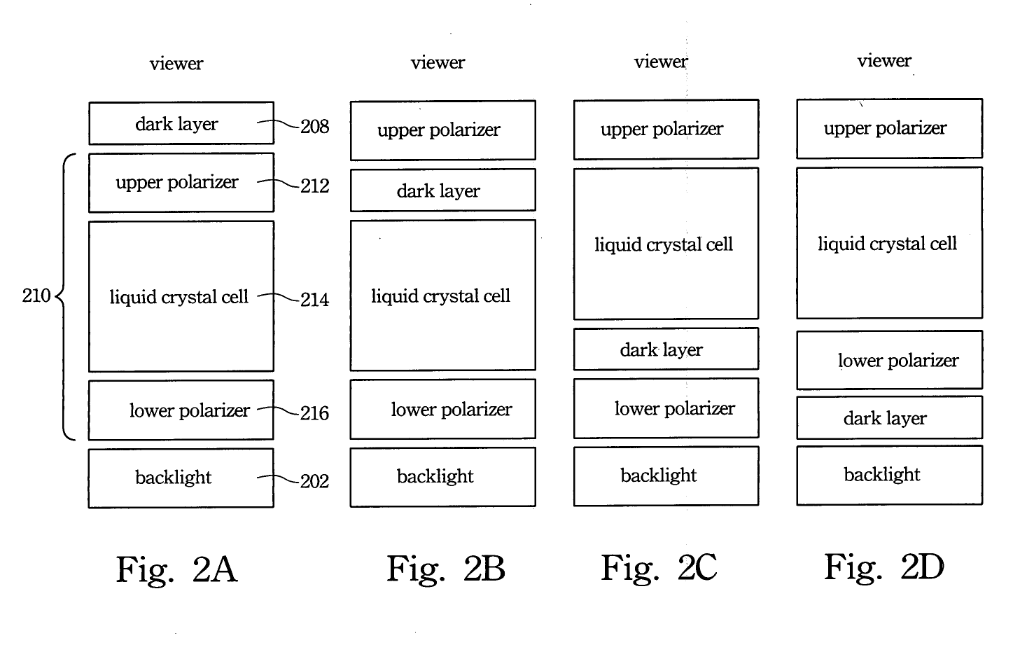

FIGS. 2A, 2B, 2C, and 2D illustrate schematic views of four preferred embodiments of a liquid crystal display of the invention. The liquid crystal display includes a liquid crystal display panel 210, a backlight 202 and a dark layer 208. The liquid crystal display panel 210 has an upper polarizer 212, a liquid crystal cell 214 and a lower polarizer 216. The two polarizers 212 and 216 both have wide view optical compensation films (not illustrated in the figures). In these preferred embodiments, each of the wide view optical compensation films is placed on one side of the polarizer 212 or 216, which is close to the liquid crystal cell 214. The light of the backlight 202 is sequentially transmitted to a viewer through the lower polarizer 216, the liquid crystal cell 214, and the upper polarizer 212.

As illustrated in these four figures, the position of the dark layer 208 is alternatively on an outside of the upper polarizer 212 close to the viewer (as illustrated in FIG. 2A), between the upper polarizer 212 and the liquid crystal cell 214 (as illustrated in FIG. 2B), between the lower polarizer 216 and the liquid crystal cell 214 (as illustrated in FIG. 2C), or between the lower polarizer 216 and the backlight 202 (as illustrated in FIG. 2D). It is noted that the improvement of the light leak of the downward angle view is better when the position of the dark layer 208 is closer to the viewer.

In these embodiments illustrated in FIGS. 2A-2D, the dark layer 208 is a black dye coating layer. According to the shading requirement, a black dye, such as a AAA, is adequately mixed with a solvent, like Methyl Ethyl Ketone (MEK), Isopropyl Alcohol (IPA), Toluene or Xylene, to provide a solution. Then, by an applicable coating method, such as wire-bar coating, a micro gravure coating or offset coating, the solution is coated on the polarizer 212 or 216 having the wide view optical compensation film thereof.

Finally, the solvent of the solution is evaporated by heating with an oven at a suitable temperature for a suitable time, or stored at room temperature until the solvent is vaporized. The wide view polarizers 212 and 216 improving the light leak of the downward angle view are therefore obtained. The liquid crystal display using wide view polarizers 212 and 216 satisfies both the requirements of wide view-angle and high contrast ratio of the liquid crystal display.

Table 1 is a comparison sheet of the prior art and one preferred embodiment of the present invention, and lists the central light-state brightnesses, the central dark-state brightnesses, the central contrast ratios, the 70° downward angle view dark-state brightnesses, and the 70° downward angle view contrast ratios of the polarizer without and with the dark layers. The polarizers having the dark layers in Table 1 have two concentrations, 1% and 2%, of black dye.

TABLE 1
Comparison of the prior art and one preferred embodiment of
the present invention.

| | Central | Central | | 70° down- | 70° down- |
|---|---|---|---|---|---|
| | light- | dark- | | ward | ward |
| | state | state | Central | angle view | angle |
| | bright- | bright- | contrast | dark-state | view contrast |
| | ness | ness | ratio | brightness | ratio |
| No black dye | 235.7 | 0.335 | 375.8 | 5.60 | 8.0 |
| 1% black | 231.6 | 0.353 | 370.0 | 5.56 | 9.1 |
| dye | | | | | |
| 2% black | 220.9 | 0.436 | 311.2 | 4.30 | 10.3 |
| dye | | | | | |

As illustrated in Table 1, the invention certainly improves the downward angle view contrast ratio of the liquid crystal display. Moreover, the downward angle view contrast ratio is enhanced by increasing the concentration of the black dye of the dark layer. In this preferred embodiment, the downward angle view contrast ratio is greater than 10 when the concentration of the black dye is greater than 2%, which fits the requirement of the downward angle view contrast of the liquid crystal display.

The dark layer of the invention, in addition to the black dye coating layer, also can be an adhesive layer with the black dye of the liquid crystal display.

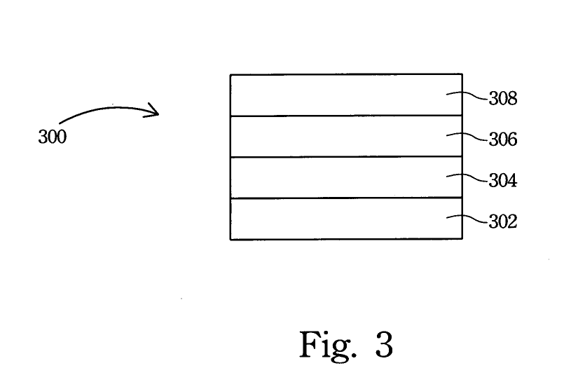

Generally, the upper polarizer 212 or the lower polarizer 216 in FIG. 2A is formed by multiple films. FIG. 3 illustrates a schematic view of one preferred embodiment of the polarizer of the invention. As illustrated in FIG. 3, the polarizer 300 of the invention includes a protective film 302, a supporting film 304, a polarizing film 306, and a wide view optical compensation film 308. A material of the supporting film 304 usually is Triacetyl-Cellulose (TAC), and a material of the polarizing film 306 usually is Polyvinyl Alcohol (PVA).

Adhesive layers are usually used to adhere the protective film 302, supporting film 304, polarizing film 306 and wide view optical compensation film 308 (not illustrated in the figure). Therefore, the dark layer of the invention can be inserted while adhering the foregoing films, by inserting a black dye coating layer, or directly mixing the black dye into any adhesive layer of the wide view polarizer 300. Furthermore, the adhesive layer with the black dye can be placed on the outside of the wide view polarizer 300, or between the upper polarizer 212, the liquid crystal cell 214 and the lower polarizer 216 in FIGS. 2A-2D for adhering therebetween.

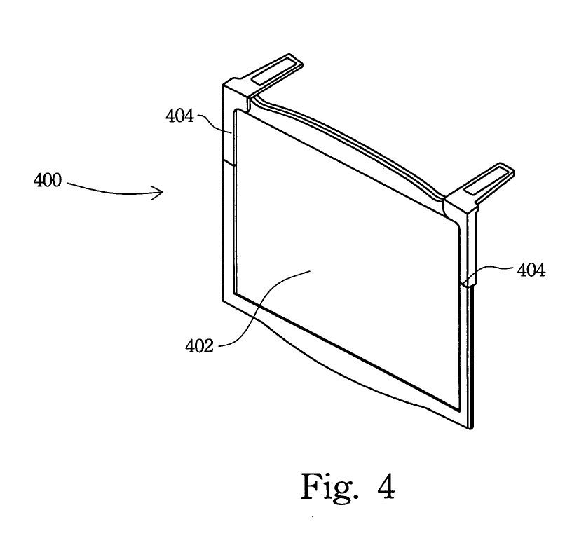

FIG. 4 illustrates a schematic view of one preferred embodiment of the shading apparatus of the invention. According to the preferred embodiment, the invention provides a shading apparatus to lower a dark-state brightness of the liquid crystal display to improve a downward angle view contrast ratio of the liquid crystal display. The shading apparatus includes a dark layer 402 and a fixing apparatus 404, and is fixed on the liquid crystal display by the fixing apparatus, such as hangers or a fixed support, such that the shading apparatus is between the liquid crystal display and a viewer. In this embodiment, the dark layer 402 is a transparent substrate mixed with a black dye. A material of the transparent substrate is polycarbonate (PC), acrylic (PMMA) or plastic.

The invention uses a simple way to solve the light leak of the conventional wide view optical compensation films, improves the contrast ratio of the liquid crystal display, and can be widely used in the liquid crystal displays of desktop computers or notebooks.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A method for enhancing contrast ratio, comprising:
providing a dark layer between a viewer and a backlight of a liquid crystal display, wherein the dark layer lowers a dark-state brightness of the liquid crystal display to improve a downward angle view contrast ratio of the liquid crystal display to greater than 10.

2. The method of claim 1, wherein providing the dark layer comprises coating a black dye on an outside of an upper polarizer of the liquid crystal display.

3. The method of claim 1, wherein providing the dark layer comprises coating a black dye between an upper polarizer and a liquid crystal cell of the liquid crystal display.

4. The method of claim 1, wherein providing the dark layer comprises coating a black dye between a lower polarizer and a liquid crystal cell of the liquid crystal display.

5. The method of claim 1, wherein providing the dark layer comprises coating a black dye between a lower polarizer and a backlight of the liquid crystal display.

6. The method of claim 1, wherein providing the dark layer comprises adding a black dye into an adhesive layer of the liquid crystal layer.

7. The method of claim 1, wherein providing the dark layer comprises placing a shading apparatus between the liquid crystal and the viewer.

8. The method of claim 1, wherein a material of the dark layer comprises a AAA.

9. A liquid crystal display, comprising:
a liquid crystal display panel, comprising:
an upper polarizer having a upper wide view optical compensation film;
a liquid crystal cell; and
a lower polarizer having a lower wide view optical compensation film;
a backlight, wherein a light emitted from the backlight is sequentially transmitted to a viewer through the lower polarizer, the liquid crystal cell, and the upper polarizer; and
a dark layer placed between the backlight and the viewer, wherein the dark layer lowers a dark-state brightness of the liquid crystal display to improve a downward angle view contrast ratio of the liquid crystal display to be greater than 10.

10. The liquid crystal display of claim 9, wherein the dark layer is a black dye coating layer.

11. The liquid crystal display of claim 10, wherein a material of the black dye is a AAA.

12. The liquid crystal display of claim 9, wherein the dark layer is an adhesive layer with a black dye.

13. The liquid crystal display of claim 12, wherein a material of the black dye is a AAA.

14. The liquid crystal display of claim 9, wherein the dark layer is placed on an outside of the upper polarizer.

15. The liquid crystal display of claim 9, wherein the dark layer is placed between the upper polarizer and the liquid crystal cell.

16. The liquid crystal display of claim 9, wherein the dark layer is placed between the lower polarizer and the liquid crystal cell.

17. The liquid crystal display of claim 9, wherein the dark layer is placed between the lower polarizer and the backlight.

18. A shading apparatus, placed between a liquid crystal display and a viewer, the shading apparatus comprising:
a dark layer, including a transparent substrate and a black dye, wherein the dark layer lowers a dark-state brightness of the liquid crystal display to improve a downward angle view contrast ratio of the liquid crystal display to be greater than 10; and
a fixing apparatus, configured on the dark layer to fix the dark layer on the liquid crystal display.

19. The apparatus of claim 18, wherein a material of the black dye is a AAA, and a material of the transparent substrate is polycarbonate, acrylic or plastic.

20. A polarizer used in a liquid crystal display, the polarizer comprising:
a supporting film;
a polarizing film on the supporting film;
a wide view optical compensation film on the polarizing film; and
a dark layer in the polarizer, wherein the dark layer lowers a dark-state brightness of the liquid crystal display to improve a downward angle view contrast ratio of the liquid crystal display to be greater than 10.

21. The polarizer of the claim 20, wherein the dark layer is an adhesive layer with a black dye.
